(19) United States
(12) Patent Application Publication
(10) Pub. No.: US 2026/0347276 A1
(43) Pub. Date: Nov. 5, 2026

(54) GRANULATED, PELLETIZED, EXTRUDED, OR OTHERWISE AGGLOMERATED FERTILIZERS UTILIZING EARTHWORM CASTINGS WITH OTHER FERTILIZER INGREDIENTS FOR ENHANCED PLANT GROWTH, SOIL FERTILITY, AND SOIL HEALTH, SYSTEM AND METHOD

(71) Applicant: Mauricio Avila, Madison, WI (US)

(72) Inventor: Mauricio Avila, Madison, WI (US)

(21) Appl. No.: 19/197,986

(22) Filed: May 3, 2025

(51) Int. Cl. C05F 17/05; C05D 9/02; C05G 1/00; C05G 5/12

(52) U.S. Cl. CPC C05F 17/05; C05D 9/02; C05G 1/00; C05G 5/12

(57) ABSTRACT

A system and method for agglomeration of earthworm castings with other fertilizer and soil amending ingredients by means of granulation, pelletizing, extrusion, or other known methods, into a homogeneous fertilizer granule that is used for improving plant growth, soil fertility, and soil health.

### FIELD OF THE INVENTION

The present invention relates to a system and method for agglomeration of earthworm castings with other fertilizer and soil amending ingredients by means of granulation, pelletizing, extrusion, or other known methods, into a homogeneous fertilizer granule that is used for improving plant growth, soil fertility, and soil health.

### BACKGROUND OF THE INVENTION

### Earthworm Castings

Earthworm Castings (EWC) can replenish soil microbiology that may be damaged or destroyed due to soil management or natural aging of engineered soil mixes or give a boost to the biology that already exists in the soil. Microbes and organic matter found in EWC work synergistically to increase nutrient cycling, retain more plant available water, inhibit or control parasitic and pathogenic biology (mostly root nematodes and fungi), and improve nutrient bioavailability, thus helping the establishment, growth, and productivity of crops, lawns, and gardens under varying conditions.

The interactions between soil organisms (the soil food web) in combination with adequate soil chemical (pH, cation exchange capacity, nutrients, phyto-hormones, and salts) and physical properties (bulk density and structure) are the building blocks for soil fertility and enhanced plant health, growth, and productivity. The primary biological groups that make up the soil food web are: nematodes, amoebas or protozoa, fungi, actinomycetes, yeasts, and bacteria.

Nematodes—non-segmented microscopic worms. Nematodes themselves are food for predatory nematodes, microarthropods, and insects and, depending on the species, they may feed on plant roots, algae, bacteria, fungi, and organic matter. Earthworm castings contain a variety of beneficial nematodes (mostly predatory nematodes) which typically help control other parasitic nematodes.

Amoebas (Protozoa)—single-celled eukaryotic microorganisms. Amoebas are important members of microbial communities and are significant links in soil food webs. Amoebas contribute to the fertility of the soil by preying on a wide variety of other organisms, including bacteria and fungi. As they feed, nitrogen and other nutrients are released (mineralization) that then can be used by plants and other members of the soil food web.

Fungi and yeast—these are soil organisms that grow either as long threads called hyphae (in the case of fungi), or as single cells, (yeast). Fungi and yeast are important decomposers in the soil food web. They convert hard to digest organic material (mostly lignin, cellulose, and hemicellulose) into simpler carbohydrate forms that other organisms like bacteria can use. Fungi are an important biological component in EWC. For example, mycorrhizal fungi form a synergistic relationship with plant roots in which the plant provides the fungi with carbohydrates (sugars) and the fungi help solubilize nutrients (i.e., phosphorus) from the soil and transport them into the plant root along with water.

Bacteria—they are microscopic single-celled microorganisms. One teaspoon of worm castings can contain over 100 million beneficial bacteria of many species belonging to multiple genera such as Bacillus spp., Trichoderma spp., etc. Bacteria consume simple carbon compounds found in organic matter (sugars, proteins/amino-acids, and others) and convert them into forms that the rest of the food web can use. When nutrients like nitrogen are abundant in the soil, bacteria can retain or immobilize them inside their cells, thus preventing them from getting lost through leaching, or other processes.

In recent years the use of EWCs has grown significantly in the US and other countries. About 60% of the industry's value is centered around agricultural uses of earthworms (waste recycling, addition of live worms to soils, etc.) and their castings (vermicompost), plus vermicompost sales for gardening and other home uses.

At the same time, the limited basic knowledge and lack of standardization in earthworm farming practices are some of the main limiting factors for the growth of this industry. A large component of the variability is the type of substrates and amendments used in the production process, but also lack of knowledge on the true limits that earthworms exhibit in terms of concentrations of the various nutrients in those substrates, bioaccumulation of certain chemical elements in the earthworm bodies, and system-driven factors such as temperature profiles, nutrient accumulation or mass loss profiles (especially nitrogen) during the vermicomposting process due to the specific characteristics of the production system such as box sizes, passive versus active aeration and cooling, and type of substrate processed (manures, agricultural residues, agro-industrial residues like produce peals, organic soils with nutrient supplementation, sewage sludge, etc.).

Data on the effects of earthworms on plant production indicates that the biggest effect of earthworms is on crop yield (15 to 35% higher) while aboveground and belowground biomass can increase around 25% over the controls. Although nearly all biomass indices are impacted, nitrogen or other nutrient concentrations in the plant may not increase proportionally, indicating that, in part, the positive effects of earthworms in agricultural yields are derived from other components (not nutrients) and effects (plant protection, hormonal, etc.) exerted by the worms and their castings on the soil and the plants.

Enhanced seed germination may be due to the presence of humic substances in the vermicompost that work like plant-growth hormones such as gibberellins and auxins.

Earthworms accelerate the decomposition of organic residues and their incorporation with the soil particles, thus improving soil aggregation, water infiltration, moisture retention, microbial populations and activity, nutrient availability, humification of organic matter, and other parameters associated with soil health and fertility. However, controlling earthworm populations in agricultural, garden, and potted soils is not practical, thus processing organic materials in vermicomposting “factories” is a more efficient pathway that can generate standardized material that is easy to apply in quantities properly prescribed to improve soils and enhance plant growth with adequate predictability. Ensuring proper maturity and stability of the products is also key for adequate vermicompost performance, especially when used for germination of seeds.

Other important effects of earthworm castings are pest and disease suppression. The mechanisms for pest control can range from induction of systemic resistance in the plant to direct suppression by the microflora and microfauna of the vermicompost or by parasitism of vermicompost biology on plant-harming nematodes and other pests.

It has been found that the application of vermicompost is accompanied by plant growth effects that are not the result of higher nutrient concentrations, but of plant growth boosting like that induced by growth hormones such as gibberellins and auxins.

Earthworm castings contain large concentrations of digested organic matter products that are readily available for further microbial digestion and assimilation, and they often induce increased microbial activity for a few weeks after being deposited in the soil. Although this process is quite different between earthworm castings from wild soil earthworms versus vermicompost from farmed earthworms, stabilized earthworm castings can boost microbial activity of the soil for a few weeks after their application.

One of the most important contributions of EWCs is the increased water retention and availability. This indicates that soil structure, macropores, and micropores increase because of vermicompost applications. Macropores let more water move into and through the soil, while micropores hold more available water for the plants. When used in containerized agriculture vermicompost increases bulk density and available water holding capacity of the substrate mixes, with consequent increases in nutrient retention (cation exchange capacity), cycling, and availability, reduced leaching of nutrients like nitrates, and better overall crop performance.

From a chemical standpoint, the addition of nutrients is one of the main benefits of vermicompost use, but its effects on pH and pH buffering are also critical. Vermicompost can often raise the pH of acidic soils due to alkalinity and pH buffering capacity provided by the organic matter in it. Finally, because vermicompost contains significant quantities of calcium and magnesium and low concentrations of salts, and improves water movement, it can be a useful tool for managing soils afflicted by salinity and sodicity problems, which are common in dry and desert regions.

Vermicompost can be applied at varying rates, from a few hundred pounds to more than 8 ton/acre, but typically the high rates are not economically viable for field crops and, even though in home gardens the economics of high rates are not a critical factor, most earthworm castings alone do not provide the full complement of nutrients needed to carry most crops to harvest.

Nutritionally, although a high dose of earthworm castings can introduce significant amounts of nutrients like organic nitrogen, only about 25 to 50% of a crop's nutrient budget will be released in a 5-to-8-week period depending on C: N ratio, soil pH, mode of application, etc. In contrast standardized synthetic fertilizers can provide the needed nutrients with typical rates between 0.5 and 1 ton (1,000 to 2,000 lb) per acre whereas organic and organo-mineral fertilizers can provide a full nutrient complement at rates of one to two tons (2,000 to 4,000 lb) per acre.

### Organic and Organo-Mineral Fertilizers

Historically, organic fertilizers like manures (raw, composted, or granulated), blood, feather, and bone meals, and many others, have been used successfully in organic agriculture. However, because of their inherent variability in nutrient composition, moisture content and release curves (particularly for nitrogen) a variety of strategies have been used to standardize their nutrient contents and nutrient release behaviors. This has led to a variety of combinations such as multiproduct homogeneous granules that provide specific nutrient concentrations that farmers can trust to deliver the nutrient masses required for efficient crop production. So, a particular formulation like 8-3-8 could be achieved by combining organic ingredients like a dewatered manure (base nutrients and organic matrix), bone meal (calcium phosphate), blood or feather meal (protein/organic nitrogen), langbeinite or sunflower hull ash (potassium), zinc, copper, ferrous, or manganese sulfates (zinc, copper, iron, and manganese), and boric acid or ulexite (boron), with binding agents (i.e., lignosulfonates), biological spores and propagules, and other ingredients into a homogeneous granule using disc granulators, extruders, pelletizers, high intensity mixers, or other well established industrial methods for fertilizer agglomeration and fabrication. Alternatively, a manure (chicken, hog, bovine, etc.), or other organic matrix (bagasse, papermill sludge, cannery waste, etc.) get combined with fine standard synthetic fertilizers that provide nitrogen (urea, ammonium sulfate, ammonium nitrate, aqua ammonia, etc.), phosphorus (rock phosphate, triple superphosphate, mono-or di-ammonium phosphate, etc.), potassium (potassium chloride, potassium sulfate, langbeinite, etc.), and micronutrient sources (zinc, copper, manganese, and ferrous sulfates, boric acid, etc.) into homogeneous granules with the specific nutrient concentrations desired. Furthermore, granulated manures can be combined with granulated standard fertilizers (urea, triple superphosphate, mono-ammonium phosphate, di-ammonium phosphate, ammonium nitrate, potassium chloride, potassium sulfate, kieserite, and many others) into a physical blend that accomplishes the same goal of desired formula.

### Organic and Organo-Mineral Fertilizers Based on Earthworm Castings

Interestingly, although the advantages of combining manures with other nutrient sources to produce homogeneous granules (or physical blends) to formulate standardized fertilizers has been recognized for many years, earthworm castings have not been introduced into this chain of agricultural products. This is likely because historically earthworm castings and composts have been seen largely as sources of biological agents and organic matter (along with the associated chemistries) and not as sources of nutrients, and because of the belief that any agglomeration and drying process (granulation, pelletizing, extrusion, high intensity mixing, or similar) will automatically destroy the biological load of these materials.

Although many biological strains present in composts and manures will die in the agglomeration process, much of this biology survives in a variety of dormant states that will reactivate soon after application of the fertilizers to the soil and make great use of the concentrated nutrients available in the fertilizer granules. This has started in the organic agriculture industry where microbial loads are being made for granulated manures, and additions of specific microbial strains such as Bacillus spp., Trichoderma spp., and mycorrhizal strains (both endo and ectomycorrhiza) are taking advantage of how biological activity inside the fertilizer granule can improve nutrient availability, modulate nutrient release curves, and improve crop nutrition and soil fertility.

Although this has happened with manures, and some composts, nothing has been done in a systematic manner for the incorporation of earthworm castings into fertilizer formulations. In general, earthworm castings have recently been thriving in the market as natural and organic soil amendments and enhancers, or even as natural nutrient sources, but no agglomerated dry fertilizer formulations containing earthworm castings have been introduced.

### SUMMARY OF THE INVENTION

The present invention relates to the various ways in which earthworm castings are incorporated into multisource organic or organo-mineral fertilizers to produce highly effective fertilizers that take advantage of the unique ways in which the hybrid oxidative environment (anaerobic inside the earthworm and aerobic stabilization after excretion of the castings), alters the organic matter processed by the earthworms.

One critical aspect of earthworm castings is that they provide improved phosphorus uptake and contribute to better uptake of micronutrients such as copper and zinc as a result of their chemical interactions with humic substances in the vermicompost.

The present invention leverages the benefits of earthworm castings and the benefits of organic, synthetic, mineral, and biological fractions in fertilizer formulations to produce superior organo-mineral fertilizers that embody the following benefits/advantages:
a) Place earthworm castings'biology and organic chemistry in intimate contact with nutrient-bearing organic compounds such as, but not limited to, feather meal (organic nitrogen), bone meal (calcium and phosphorus), biochar (alkalinity, recalcitrant carbon, potassium, and porous medium for water holding, cation exchange, and microbial growth), gypsum (calcium and sulfate), sunflower hull ash (potassium, calcium, alkalinity, and other), microbial spores and propagules (Bacillus spp., Trichoderma spp., mycorrhizae, protozoa, and others).
b) Provide synergistic effects between the biology, the organic chemistry (hormonal compounds from earthworm castings, humified organic matter like fulvic and humic acids, carbon chains with high cation exchange capacity [CEC] like those in biochar) and the mineral components of the granules to promote improved bioavailability of micronutrients such as iron, copper, zinc, and manganese via chelation effects; improved cation exchange capacity inside and outside the fertilizer granules; accelerate root development and growth (especially elongation and branching promoted by auxins and gibberellins present in earthworm castings); accelerate micronutrient uptake (via chelation effects from humic compounds in earthworm castings); improve water and water-driven nutrient uptake (mass flow of calcium, magnesium, zinc, and boron) by colonization of roots with mycorrhizal strains; and promote root health by providing pathogen control agents (Trichoderma spp., predatory nematodes, protozoa, and other beneficial microbial strains present in active or dormant forms in earthworm castings or added to the granule as dormant biology).
c) Limit nutrient losses from the fertilizer granules by: incorporating exchange sites of biochar and organic matter in the fertilizer granule which upon dispersion into the soil are able to retain cations such as calcium, magnesium, potassium, and ammonium; promote uptake and assimilation of ammonium by microbes and plants; prevent nitrate leaching (by cycling free nitrates into fast cycling microbial biomass); and reduce phosphorus fixation (particularly in acid soils, by providing an organic matrix for sorption and adsorption of phosphates onto the organic matrix of the granule instead of iron and aluminum or iron-saturated or aluminum-saturated organic matter in the soil).
d) Provide organic compounds and biology as essential components of the fertilizer granules that promote better soil structure, aeration, and water availability for soil biology and crop roots, ameliorate compaction, improve water infiltration into the soil, and reduce water runoff (and associated nutrient losses).

A key property of this fertilizer technology of the present invention is the synergistic effects obtained by placing nutrients in synthetic (mainly water soluble) or organic forms (mainly water insoluble), exchange sites (from biochar and humic acids mainly), microbial foods (sugars, proteins, and other simple labile organic compounds), organic chemistry (largely hormonal compounds and humic compounds from earthworm castings, particularly), and biology (from worm castings or other sources), all in intimate contact inside a homogeneous organo-mineral granule which, upon application on the soil surface (when broadcasted) or inside the soil (when incorporated), becomes in contact with typical soil biology and moisture to kickstart intense microbial growth and nutrient cycling processes inside, on the surface, and around the fertilizer granule in ways that are not possible when the same components are applied to the soil in separate forms and locations (even if only millimeters away from each other).

The present invention provides a method to produce standardized organic or organo-mineral fertilizer formulas through various agglomeration processes or preparation of a dry worm castings granule that is used for the formulation of standardized organic or organo-mineral fertilizers by physical blends of the agglomerated earthworm castings with various organic or synthetic granules that accomplish the benefits as stated above that are not produced when the EWC is not placed into a granule with the fertilizer and other components and instead the components are all placed separately onto or inside the soil.

It is an object of the present invention for the fertilizer to combine a dormant biological load with concentrated nutrients in organic or synthetic forms that produce accelerated microbial growth, nutrient cycling, and nutrient availability to improve nutrient uptake efficiency of crops, reduce nutrient losses from the root zone, and improve crop growth and productivity. These fertilizers enhance the soil physical, chemical, and biological properties (the three prongs of the soil health spectrum) to achieve results such as:
a) add dormant biology capable of fast reactivation and growth under normal or stressed soil conditions;
b) speed nutrient release curves, improve availability, and overall cycling of nutrients present in the fertilizer granules;
c) introduce organic matter and amending components (alkalinity, buffer capacity, and some key nutrients) that improve soil physical properties such as aggregation, porosity, infiltration, and water holding capacity; and
d) introduce nutrients in sufficient quantities to satisfy the nutrient budgets of high-yielding crops in organic, conventional, or urban agriculture, and in home gardening settings.
It is an object of the present invention for the fertilizer formulations to increase plant growth.

It is an object of the present invention for the fertilizer formulations to accelerate plant growth.

It is an object of the present invention for the fertilizer formulations to improve germination.

It is an object of the present invention for the fertilizer formulations to enhance plant growth, comprising assisting in making the plants grow bigger, faster, and healthier, and providing a balanced nutrient content.

It is an object of the present invention for the fertilizer formulations to maximize yield by promoting higher weight of individual leaves, fruits, tubers, roots, or any other harvestable plant part.

It is an object of the present invention for the fertilizer formulations to maximize plant growth.

It is an object of the present invention for the fertilizer formulations to provide higher numbers of flowers and/or fruit.

It is an object of the present invention for the fertilizer formulations to increase the number of fruits.

It is an object of the present invention for the fertilizer formulations to increase the number of flowers.

It is an object of the present invention for the fertilizer formulations to increase plant height.

It is an object of the present invention for the fertilizer formulations to enhance soil chemical and biological properties.

It is an object of the present invention for the fertilizer formulations to enhance soil biodiversity.

It is an object of the present invention for the fertilizer formulations to promote beneficial soil microbiology.

It is an object of the present invention for the nutrient or biological fertilizer formulation to increase presence and quantity of plant growth and rooting hormones in treated soils.

It is an object of the present invention for the fertilizer formulations to increase the concentration of humic materials in treated soils.

It is an object of the present invention for the fertilizer formulations to increase beneficial fungal growth in treated soils.

It is an object of the present invention for the fertilizer formulations to increase nutrient levels in treated soils.

It is an object of the present invention for the fertilizer formulations to be a primary source of nutrients for plants and microbes when applied to soils at the recommended rates.

It is an object of the present invention for the fertilizer formulations to reduce the need for other fertilizers in treated soils.

It is an object of the present invention for the fertilizer formulations to contain beneficial soil microorganisms.

It is an object of the present invention for the fertilizer formulations to contain humic compounds.

It is an object of the present invention for the fertilizer formulations to provide plant biostimulant effects, above and beyond the effects exerted by nutrient contents alone.

It is an object of the present invention for the fertilizer formulations to improve seed germination and early seedling growth when used in pre-planting applications such as germination beds, planting furrows, pots, and other germination substrates.

It is an object of the present invention for the fertilizer formulations to be non-burning of roots and seedlings during and after germination.

It is an object of the present invention for the fertilizer formulations to have no unpleasant scents such as those of animal manures, fermentation wastes, fish wastes, and others which usually exhibit objectionable odors.

It is an object of the present invention to mix the fertilizer formulations into potting soil or seed starting mixes.

In a preferred embodiment, these fertilizer formulations are mixed into the soil in quantities of tens or hundreds of pounds per acre (typical of synthetic and standard fertilizers) to several tons per acre (typical of soil amendments such as lime, gypsum, and green manures, or soil conditioners such as composts and pure earthworm castings).

It is an object of the present invention to use the fertilizer formulations to amend and improve the soil in raised beds.

It is an object of the present invention for the fertilizer formulations to be added to a planting hole when transplanting.

It is an object of the present invention to use the fertilizer formulations to refresh or recharge depleted soils when applied at the recommended rates.

It is an object of the present invention to use the fertilizer formulations as a soil probiotic—an inoculant that adds beneficial microbiology to the treated soils.

It is an object of the present invention to use the fertilizer formulations as a top dressing for potted indoor and outdoor plants.

It is an object of the present invention to use the fertilizer formulations with compost, rock dust, kelp meal, fermented nutrient solutions, growth and rooting hormones, or a combination of same whenever necessary and without chemical, physical, or biological incompatibilities.

It is an object of the present invention to use the fertilizer formulations in combination with kelp, humic acid, biochar, zeolite, molasses, various ashes, mined or flue gas desulfurization gypsum, diatomaceous earth, fish, blood, bone, or meat-and-bone meals, fish hydrolysates, standard fertilizers and other nutrients.

### DETAILED DESCRIPTION OF THE INVENTION

The present invention pertains to the system and method for transformation of earthworm castings by pan granulation, extrusion, pelletizing, high intensity mixing, or other agglomeration methods that render the earthworm castings into a homogeneous granule. In an embodiment, the granules have added to them the minor addition of binding or agglomeration agents that encompass but are not limited to various lignosulfonate or other fertilizer industry agglomeration and binding agents.

In an embodiment, the granules have added to them other organic fertilizers amenable to agglomeration such as nitrogen sources, including but not limited to blood meal, feather meal, meat-and-bone meal, alfalfa meal, and other well-known organic nitrogen sources, be it raw, fermented, cooked, dewatered, or otherwise processed.

In an embodiment, the granules have added to them organic and natural mineral phosphorus sources suitable for organic agriculture, including but not limited to bone meal, meat-and-bone meal, rock phosphate of various grades and qualities, and other well-known organic phosphorous sources, either raw, fermented, cooked, dewatered, or otherwise processed.

In an embodiment, the granules contain organic or mined potassium sources suitable for organic agriculture, including but not limited to sunflower hull ash, fruit peals, fruit juices, juice waste, and other well-known organic or raw mined agricultural potassium source) either raw, fermented, cooked, dewatered, or otherwise processed.

In an embodiment, the granules have added to them other organic or mined macro-nutrient (calcium, magnesium, and sulfur) suitable for organic agriculture either raw, fermented, cooked, dewatered, or otherwise processed.

In an embodiment, the granules have added to them, other organic or mined micronutrient sources (iron, copper, zinc, manganese, boron, molybdenum, and any other micronutrient of agricultural interest) suitable for organic agriculture, either raw, fermented, cooked, dewatered, or otherwise processed.

The quantities of the different materials needed for a formulation are calculated using a mass balance and concentrations calculator that accounts for nutrient concentrations in the different forms (organic, or inorganic, or even in specific ionic forms) present in the different materials and changes in water contents during the agglomeration process to achieve a desired formulation with specific concentrations of such nutrients (nitrogen, phosphorus, potassium, calcium, magnesium, sulfur, copper, iron, manganese, zinc, boron, molybdenum, nickel, or any other of plant nutrition importance) for general or specialized plant growth objectives, and estimation of undesirable chemical contents (such as sodium, chloride, aluminum, or others), or other components of positive or negative importance for crop growth and productivity including hormones, biological spores or live organisms, or any other of general or specific interest for general or specialized plant growth objectives.

In an embodiment, agglomeration of single or multi-source fertilizers is performed in a variety of stepwise processes such as pan granulation, high intensity mixing granulation, pelletizing, extrusion, and others known in the fertilizer industry. All these involve a series of steps that usually follow a sequence:
a) calculation of ingredient proportions and quantities, and estimation of nutrient contents of a formula;
b) weighing of ingredients;
c) slow but thorough wet, fresh, or dry mixing of the ingredients to ensure uniformity in the composition of the final granules;
d) addition of moisture and agglomeration agents to levels amenable to the agglomeration process;
e) processing of the mixture until agglomeration reaches the desired particle size distribution and aggregate quality;
f) drying of the aggregates;
g) sieving to the proper particle size range (varying from 0.5 to 25 mm depending on the final use objectives);
h) re-grinding of off-sized particles;
i) recycling of ground off-sized particles back to the start of the process
j) quality control, bagging, and labeling of the final product.

The range of products that could be formulated is expansive, but falls within the following specifications and characteristics:
a) Concentrations of earthworm castings ranging from 5 to 95% of the dry matter in the final product;
b) 1 to 5.0% agglomeration agents including but not limited to lignosulfonates, organic gums, and other such agents well-known in the fertilizer industry;
c) Organic carbon content ranging from 1.0% to 25% with individual product variations inside that range depending on the intended use;
d) Nitrogen concentrations ranging from 0.5% to 30% with individual product variations inside that range depending on the intended use;
e) Phosphorus concentrations ranging from 0.1% to 15% with individual product variations inside that range depending on the intended use ;
f) Potassium concentrations ranging from 0.1% to 30% with individual product variations inside that range depending on the intended use;
g) Calcium concentrations ranging from 1.0% to 20% with individual product variations inside that range depending on the intended use;
h) Magnesium concentrations ranging from 0.5% to 10% with individual product variations inside that range depending on the intended use;
i) Sulfur concentrations ranging from 0.1% to 10% with individual product variations inside that range depending on the intended use;
j) Iron concentrations ranging from 0.1% to 5.0% with individual product variations inside that range depending on the intended use;
k) Individual micronutrient (manganese, copper, zinc, boron, molybdenum, and nickel) concentrations ranging from 1 to 5,000 parts per million with individual product variations inside that range depending on the intended use;
l) Particle size distribution ranging from 0.1 mm to 25 mm with individual product variations inside that range depending on the intended use;
m) Concentrations of biological spores and dormant organisms ranging from 0.1%to 1.0% with individual product variations inside that range depending on the intended use;
n) Crush strength ranging from 5.6 to 7.9 lb (25 to 35 newton) per granule with individual product variations inside that range depending on the intended use.

1. Earthworm castings incorporated into standardized multi-source organic or organo-mineral fertilizer granules where intimate contact of dormant biology with nutrients, organic chemistries, and minerals produces synergistic effects that improve nutrient cycling, plant nutrient uptake, plant growth and health, overall crop yield and performance, and any combination.

2. The fertilizer granules of claim 1 wherein said fertilizer granules provide improved phosphorus uptake and contribute to better uptake of micronutrients such as copper and zinc as a result of their chemical interactions with humic substances in vermicompost.

3. The fertilizer granules of claim 1 wherein said fertilizer granules in intimate contact with nutrient-bearing organic compounds.

4. The fertilizer granules of claim 3 wherein said nutrient-bearing compounds comprise feather meal (organic nitrogen), bone meal (calcium and phosphorus), biochar (alkalinity, recalcitrant carbon, potassium, and porous medium for water holding, cation exchange, and microbial growth), gypsum (calcium and sulfate), sunflower hull ash (potassium, calcium, alkalinity, and other), microbial spores and propagules (Bacillus spp., Trichoderma spp., mycorrhizae, and protozoa).

5. The fertilizer granules of claim 1 wherein said fertilizer granules provide synergistic effects between biology, organic chemistry (hormonal compounds from earthworm castings, humified organic matter including fulvic and humic acids, high-CEC carbon chains in biochar) and mineral components of granules to promote improved bioavailability of micronutrients such as iron, copper, zinc, and manganese via chelation effects; improved cation exchange capacity inside and outside said fertilizer granules; accelerate root development and growth, especially elongation and branching promoted by auxins and gibberellins present in said earthworm castings; accelerate micronutrient uptake (via chelation effects from humic compounds in said earthworm castings); improve water and water-driven nutrient uptake (mass flow of calcium, magnesium, zinc, and boron) by colonization of roots with mycorrhizal strains; and promote root health by providing pathogen control agents (Trichoderma spp., predatory nematodes, protozoa, and other beneficial microbial strains present in active or dormant forms in earthworm castings or added to said granule as dormant biology).

6. The fertilizer granules of claim 1 wherein said fertilizer granules limit nutrient losses by: incorporating exchange sites of biochar and organic matter in said fertilizer granule which upon dispersion into soil retain cations, including calcium, magnesium, potassium, and ammonium; promote uptake and assimilation of ammonium by microbes and plants; prevent nitrate leaching by cycling free nitrates into fast cycling microbial biomass; and reduce phosphorus fixation, particularly in acid soils, by providing an organic matrix for sorption and adsorption of phosphates onto organic matrix of said granule instead of iron and aluminum or iron-saturated or aluminum-saturated organic matter or aluminum and iron oxyhydroxides in said soil.

7. The fertilizer granules of claim 1 wherein said fertilizer granules provide organic compounds and biology as essential components of said fertilizer granules that promote better soil structure, aeration, and water availability for soil biology and crop roots, ameliorate compaction, improve water infiltration into the soil, and reduce water runoff and associated nutrient losses.

8. The fertilizer granules of claim 1 wherein said fertilizer granules provide synergistic effects obtained by placing nutrients (in synthetic-mainly water soluble, or organic forms-mainly water insoluble), exchange sites (from biochar and humic acids mainly), microbial foods (sugars, lipids, and proteins), organic chemistry (hormonal compounds and humic compounds from earthworm castings), and biology (mainly from worm castings), all in intimate contact inside said fertilizer granule, upon application on soil surface (when broadcasted) or inside said soil (when incorporated), and said granule in contact with soil biology and moisture to kickstart intense microbial biology growth and nutrient cycling processes inside, on the surface, and around said fertilizer granule in ways not possible when same components are applied to said soil in separate form and locations, even if only millimeters away from each other.

9. A method to produce organic or organo-mineral fertilizer granules with earth worm castings through agglomeration processes or preparation of dry worm castings granules by physical blends of said agglomerated earthworm castings with organic or synthetic granules.

10. The method of claim 9 wherein said fertilizer granule combines a dormant biological load with concentrated nutrients in organic or synthetic forms that produce accelerated microbial growth, nutrient cycling, and nutrient availability to improve nutrient efficiency, reduce nutrient losses from root zone, and improve crop growth and productivity.

11. The method of claim 9 wherein said fertilizer granules enhance the soil physical, chemical, and biological properties by adding dormant biology capable of fast reactivation and growth under normal or stressed soil conditions; accelerate nutrient release curves, improve availability, and overall cycling of nutrients present in said fertilizer granules; introduce organic matter and amending components (alkalinity, buffer capacity, and nutrients) that improve soil physical properties, aggregation, porosity, infiltration, and water holding capacity; and introduce nutrients in sufficient quantities to satisfy nutrient budgets of high-yielding crops in organic, conventional, or urban agriculture and gardening settings.

12. The method of claim 9 wherein said fertilizer granules increase plant growth, increase plant height, accelerate plant growth, improve germination, increases nutrient levels in treated soils, provide higher numbers of flowers and/or fruit, maximize yield by promoting higher weight of individual leaves, fruits, tubers, roots, or other harvestable plant part or any combination.

13. The method of claim 9 wherein said fertilizer granules enhance plant growth, comprising assisting in making plants grow bigger, faster and healthier; and providing a balanced nutrient content.

14. The method of claim 9 wherein said fertilizer granules enhance soil chemical and biological properties, enhance soil biodiversity, promote beneficial soil microbiology or any combination.

15. The method of claim 9 wherein said fertilizer granule increases concentration of humic materials in treated soils.

16. The method of claim 9 wherein said fertilizer granule increases beneficial fungal growth in treated soils, reduces need for other fertilizers in treated soils, amend and improve soil in raised beds, refresh or recharge depleted soils, is non-burning of roots and seedlings during and after germinations, or any combination.

17. The method of claim 9 wherein said fertilizer granule is a primary source of nutrients for plants and microbes when applied to soils at recommended rates.

18. The method of claim 9 wherein said fertilizer granule contains beneficial soil microorganisms, contains humic compounds, or any combination.

19. The method of claim 9 wherein said fertilizer granule exerts plant biostimulant effects, beyond effects exerted by nutrient content alone.

20. The method of claim 9 wherein said fertilizer granule improves seed germination and early seedling growth when used in pre-planting applications for germination beds, planting furrows, pots, and other germination substrates.

21. The method of claim 9 wherein said fertilizer granule has no unpleasant scents including animal manures, fermentation wastes, and other objectionable odors.

22. The method of claim 9 wherein said fertilizer granule is mixed into potting soil or seed starting mix.

23. The method of claim 9 wherein said fertilizer granule is mixed into soil in quantities of tens or hundreds of pounds per acre to several tons per acre typical of soil amendments such as lime, gypsum, and green manures, or soil conditioners, including composts and pure earthworm castings.

24. The method of claim 9 wherein said fertilizer granules are added to a planting hole when transplanting.

25. The method of claim 9 wherein said fertilizer granules are used as a soil probiotic an inoculant that adds beneficial microbiology to treated soils.

26. The method of claim 9 wherein said fertilizer granules are used as a top dressing for potted indoor and outdoor plants.

27. The method of claim 9 wherein said fertilizer granules are used in combination with compost, rock dust, kelp meal, fermented nutrient solutions, growth and rooting hormones without chemical, physical, or biological incompatibilities.

28. The method of claim 9 wherein said fertilizer granules are used in combination with kelp, humic acid, biochar, zeolite, molasses, various ashes, gypsum, diatomaceous earth, fish, blood, or bone meals, fish hydrolysates, fertilizers and nutrients.

29. A method of creating a fertilizer granule including earthworm castings comprising: transforming said earthworm castings granules by pan granulation, extrusion, pelletizing, high intensity mixing, or other agglomeration methods that renders said earthworm castings into a homogeneous granule.

30. The method of claim 29 wherein said granules have added to them minor amounts of binding or agglomeration agents that encompass lignosulfonates or other fertilizer agglomeration and binding agents.

31. The method of claim 29 wherein said granule has added to it other organic fertilizers amenable to agglomeration, including nitrogen sources, blood meal, feather meal, bone meal, meat-and-bone meal, alfalfa meal, and other organic nitrogen sources, raw, fermented, cooked, dewatered, or otherwise processed.

32. The method of claim 29 wherein said granule has added to it organic and natural mineral phosphorus sources suitable for organic agriculture, including bone meal, meat-and-bone meal, rock phosphate, and other organic phosphorous sources, either raw, fermented, cooked, dewatered, or otherwise processed.

33. The method of claim 29 wherein said granule has added to it organic or mined potassium sources suitable for organic agriculture, including sunflower hull ash, fruit peals, fruit juices or juice waste, and other organic or raw mined agricultural potassium sources either raw, fermented, cooked, dewatered, or otherwise processed.

34. The method of claim 29 wherein said granule has added to it other organic or mined macro-nutrient (calcium, magnesium, and sulfur) suitable for organic agriculture either raw, fermented, cooked, dewatered, or otherwise processed.

35. The method of claim 29 wherein said granule has added to it, other organic or mined micronutrient (iron, copper, zinc, manganese, boron, molybdenum) sources suitable for organic agriculture, either raw, fermented, cooked, dewatered, or otherwise processed.

36. The method of claim 29 wherein quantities of different materials needed for said granule are calculated using a mass balance and concentrations calculator that accounts for nutrient concentrations in different forms present in different materials and changes in water contents during said agglomeration process to achieve a desired formulation with specific concentrations of such nutrients (nitrogen, phosphorus, potassium, calcium, magnesium, sulfur, copper, iron, manganese, zinc, boron, molybdenum, nickel) for plant growth, and estimation of undesirable chemical contents (including sodium, chloride, or aluminum), and biological spores (or live organisms) desired for specific plant growth objectives.

37. The method of claim 29 wherein said agglomeration of said fertilizer granule is performed in stepwise processes, including pan granulation, high-intensity mixing granulation, mold pelletizing, extrusion.

38. The method of claim 29 further comprising:
a) calculation of ingredient proportions and quantities and estimation of nutrient contents of a formula;
b) weighing of ingredients;
c) slow but thorough wet or dry mixing of said ingredients to ensure uniformity in composition of final granules;
d) addition of moisture and agglomeration agents to levels amenable to said agglomeration;
e) processing mixture until said agglomeration reaches desired particle size distribution and aggregate quality;
f) drying of aggregates;
g) sieving to proper particle size range (0.5 to 25 mm);
h) re-grinding of off-sized particles;
i) recycling of ground off-sized particles back to the start of the process
j) quality control, bagging, and labeling of final product.

39. The method of claim 38 wherein said final product has a concentration of said earthworm castings from 5.0% to 95% of dry matter.

40. The method of claim 38 wherein said final product has 1.0% to 5.0% agglomeration agents including lignosulfonates, organic gums.

41. The method of claim 38 wherein said final product has an organic carbon content from 1.0% to 25%.

42. The method of claim 38 wherein said final product has nitrogen concentrations from 0.5% to 30%.

43. The method of claim 38 wherein said final product has a phosphorus concentration ranging from 0.1% to 15%.

44. The method of claim 38 wherein said final product has a potassium concentration from 0.1% to 30%.

45. The method of claim 38 wherein said final product has calcium concentrations ranging from 1.0% to 20%.

46. The method of claim 38 wherein said final product has magnesium concentrations from 0.5% to 10%.

47. The method of claim 38 wherein said final product has sulfur concentrations from 0.1% to 10%.

48. The method of claim 38 wherein said final product has iron concentrations from 0.1% to 5.0%.

49. The method of claim 38 wherein said final product has individual micronutrient (manganese, copper, zinc, boron, molybdenum, and nickel) concentrations from 1 to 5,000 parts per million.

50. The method of claim 38 wherein said final product has a particle size distribution ranging from 0.1 mm to 25 mm.

51. The method of claim 38 wherein said final product has concentrations of biological spores and dormant organisms ranging from 0.1% to 1.0%.

52. The method of claim 41 wherein said final product has a crush strength ranging from 5.6 to 7.9 lb (25 to 35 newton) per granule.
